(19) United States
(12) Patent Application Publication
(10) Pub. No.: US 2025/0029233 A1
(43) Pub. Date: Jan. 23, 2025

(54) Detection of Defects by Natural Language Description

(71) Applicant: AI QUALISENSE 2021 LTD, Tel Aviv-Yafo (IL)

(72) Inventors: Nir Karasikov, Tel Aviv (IL); Enno De Lange, Tel Aviv (IL); Karina Odinaev, Tel Aviv (IL)

(73) Assignee: AI QUALISENSE 2021 LTD, Tel Aviv-Yafo (IL)

(21) Appl. No.: 18/770,611

(22) Filed: Jul. 11, 2024

Related U.S. Application Data
(60) Provisional application No. 63/513,107, filed on Jul. 11, 2023.

(51) Int. Cl. G06T 7/00; G06F 40/242

(52) U.S. Cl. CPC G06T 7/001; G06F 40/242; G06T 2207/20081; G06T 2207/20084; G06T 2207/30108

(57) ABSTRACT

A method for detecting faulty manufactured items based on natural language descriptions (NLDs), the method may include: (i) obtaining one or more neural networks (NNs) that are trained to detect objects that exhibit one or more textual features of a group of textual features; wherein members of the group are defined by NLDs; wherein the one or more NNs are trained on one or more training datasets, the training datasets are not based on sensed information units (SIUs) of the manufactured items; (ii) receiving a SIU that captures an evaluated manufactured item (EMI); (iii) processing the SIU of the EMI by the one or more NNs, to provide one or more NN processing results regarding one or more relationships between the EMI and the one or more textual features; and (iv) determining a status of the EMI, based on one or more decision rules and the one or more NN processing results.

### BACKGROUND OF THE INVENTION

Manufactured items may exhibit defects. The defects may be represented by machine learning features that usually have numerical values—that may not be understood to a human.

In addition, while human operators may provide a coarse textual description of defects—this textual description is not used in automatic defect detection processes—and valuable information generated by human operators is lost.

There is a growing need to integrate, in an efficient manner, textual description of defects and a machine learning based defect detection method,

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a method;

FIG. 4 illustrates an example of a method; and

FIG. 5 illustrates an example of a computerized system.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There are provided methods for generating objects that can be identified by natural language descriptors (NLDs)—also referred to low-level natural language examples—and identifying relevant network features.

The method may include starting from a word (textual) dictionary, generating synthetic visualizations for the descriptors in the dictionary, generating features and assigning feature importance per word descriptor.

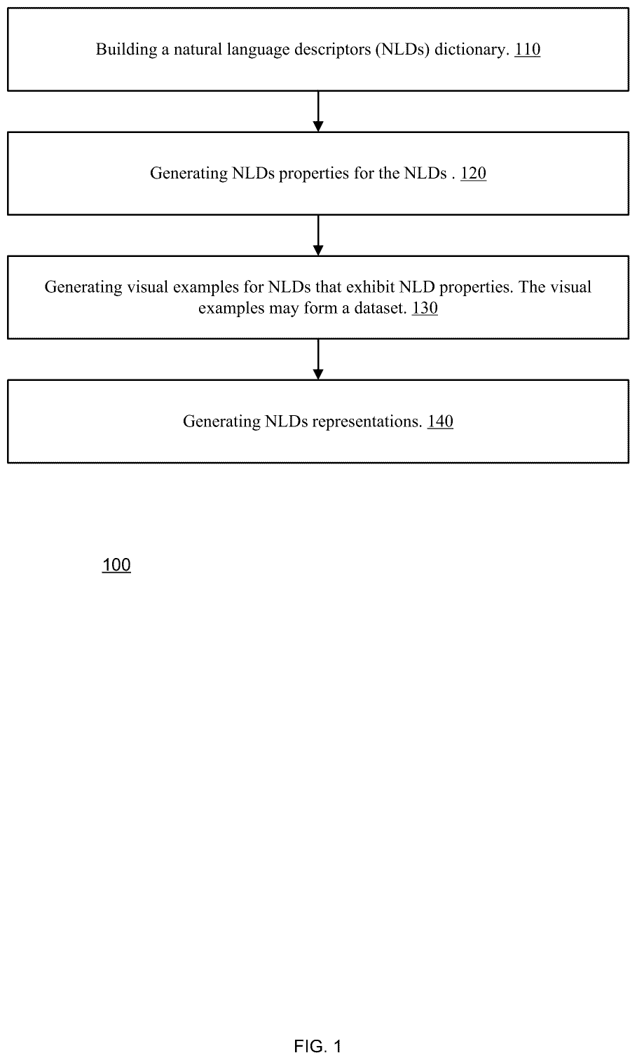

FIG. 1 illustrates a method 100.

Method 100 may start by step 110 of building a natural language descriptors (NLDs) dictionary (examples: elongated, rough edges, black, oval, etc.).

Step 110 may be following by step 120 of generating NLDs properties for the NLDs (for example NLD “oval” may be associated with a NLD property of a height/width ratio). The NLD properties are measurable properties that can be learnt—for example—from image processing.

Step 120 may be followed by step 130 of generating visual examples for NLDs that exhibit NLD properties. The visual examples may form a dataset.

Examples for ways to generate such visual examples:
a. Find objected described by NLDs using a search engine (the NLDs can be textual queries), and scrape the search results (the results don't have to be clean). For
b. With photo editing applications generate examples appearances of NLDs and NLDs properties (e.g. various ovals with a certain ratio) in different colors, widths, sizes etc).
c. Generative Adversarial Network, GAN used for synthetic dataset generation:
   i. Input: input images of test objects that exhibit NLDs with NLD properties (example: “Black straight line on white canvas”), line having a length of 20-30 centimeter, ball having a radius of 20 centimeters.
   ii. Outputs: output images (number of output images exceeds the number of the input images) generated synthetically by GAN (example: Images displaying a black straight line on a white canvas) more variations—ten input images of cracks—generate images of more cracks. For example—input images of an item of two different lengths—the output images may include images of the item with lengths between the two different lengths. The output images may include more examples of objects that those captured in the input images.

Step 130 may be followed by step 140 of generating NLDs representations.

The generating of step 140 may use the visual examples from step 130.

The visual examples are related to NLDs that exhibit NLD properties.

Step 140 may include, repeating for each NLD or for each NLD property:
a. Generating representations (for example—signatures or feature vectors or feature maps) for visual examples associated with the NLD or with the NLD property. he representation may be generated using a machine learning process or in any other manner.
b. Selecting, out of the representations, selected representations. The selected representations may be more frequent representation and/or more unique representations that may be used to represent the NLD or the NLD property.
c. Defining the selected representations as representing the NLD or representing the NLD property.

Step 140 may include training a machine learning process to detect objects that are identified (for example are tagged) by a certain NLD or exhibit (and may be tagged) one or more NLD properties. For example—feed a neural network with images of objects that are described by a certain NLD or by that exhibit a certain NLD property—and use different neural networks that may identify different objects that exhibit different properties.

During inference, images may be obtained, representation of the images may be generated and compared to reference representations that may include selected representations that represent one or more NLD or representing one or more NLD properties—to find a match.

The selected representations may be clustered to provide clusters, cluster representations may be generated and sued during inference.

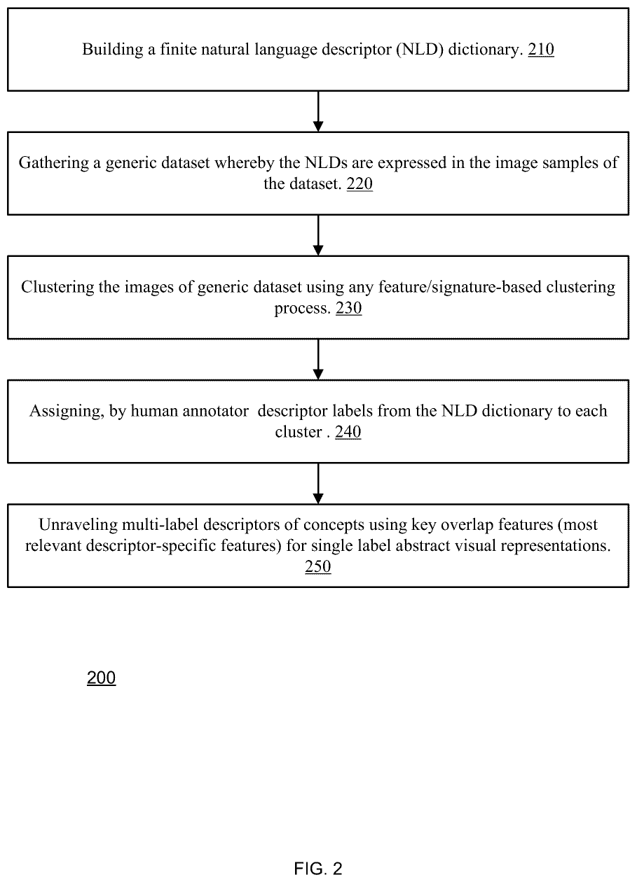

FIG. 2 illustrates method 200.

Method 200 may start by step 210 of building a finite NLD dictionary (examples: elongated, rough edges, black, oval, etc.).

Step 210 may be followed by step 220 of gathering a generic dataset whereby the NLDs are expressed in the image samples of the dataset—for example may be included in a metadata associated with the dataset, may be tags, and the like.

Step 220 may be followed by step 230 of clustering the images of generic dataset using any feature/signature-based clustering process.

Examples of clustering include:
a. Clustering of image concepts/signatures based on the feature vectors and/or feature maps similarity of image patches.
b. Clustering images by feature vector and/or feature maps based distributions as described in COR419, COR428 and COR432.

Step 230 may be followed by step 240 of assigning, by human annotator descriptor labels from the NLD dictionary to each cluster (one or a combination of multiple descriptor labels may be assigned to each cluster).

Step 240 may be followed by step 250 of unraveling multi-label descriptors of concepts using key overlap features (most relevant descriptor-specific features) for single label abstract visual representations. Examples of finding key overlap features for single label abstract visual representations include:
1. Feature Importance Permutations.
2. Marginal Mutual Information Gain.
3. Gini Importance calculating node impurity of feature importance.

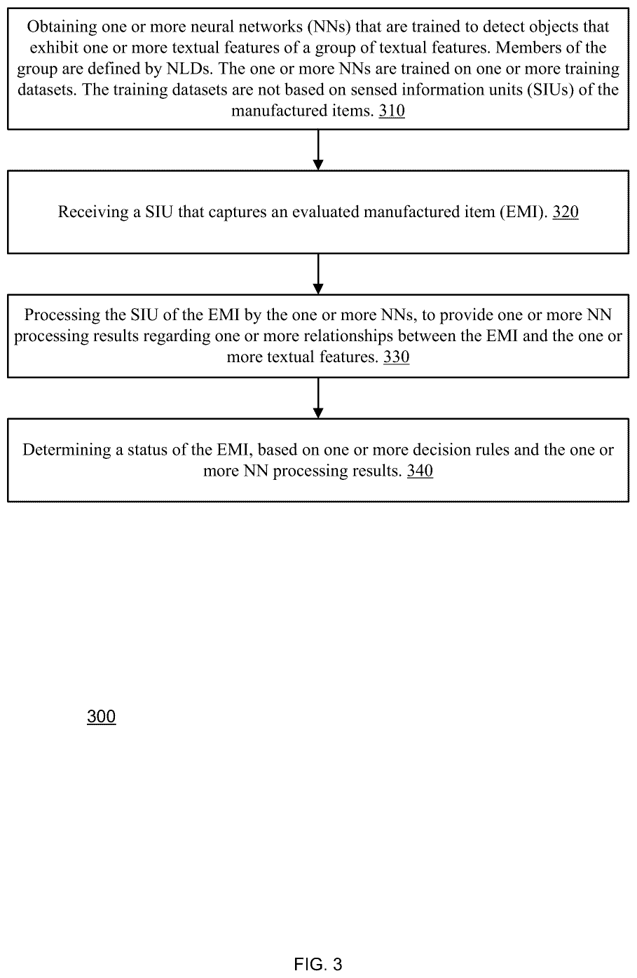

FIG. 3 illustrates an example of method 300 for detecting faulty manufactured items based on natural language descriptions (NLDs).

Method 300 may start by step 310 of obtaining one or more neural networks (NNs) that are trained to detect objects that exhibit one or more textual features of a group of textual features. Members of the group are defined by NLDs.

The one or more NNs are trained on one or more training datasets. The training datasets are not based on sensed information units (SIUs) of the manufactured items. In this sense—the one or more NNs were not tailored to identify NLDs of the manufactured items.

Step 310 may be followed by step 320 of receiving a SIU that captures an evaluated manufactured item (EMI).

Step 320 may be followed by step 330 of processing the SIU of the EMI by the one or more NNs, to provide one or more NN processing results regarding one or more relationships between the EMI and the one or more textual features.
a. The one or more NN processing results may include one or more features match indications that indicate that the EMI exhibits the one or more textual features—that can be described by one or more NLDs.
b. The one or more NN processing results may include one or more features match indications that indicate that (i) the EMI exhibits the one or more textual features, and (ii) a degree of at least one textual feature of the one or more textual features. The degree may be an amount of match to the textual feature, a dimension of a numeric value that may be more accurate that a generate textual features.
c. The one or more NN processing results may include one or more features match indications that indicate that (i) the EMI exhibits the one or more textual features, and (ii) additional information regarding at least one textual feature of the one or more features.

Step 330 may be followed by step 340 of determining a status of the EMI, based on one or more decision rules and the one or more NN processing results.

Step 340 may include determining whether the EMI comprises one or more defects.

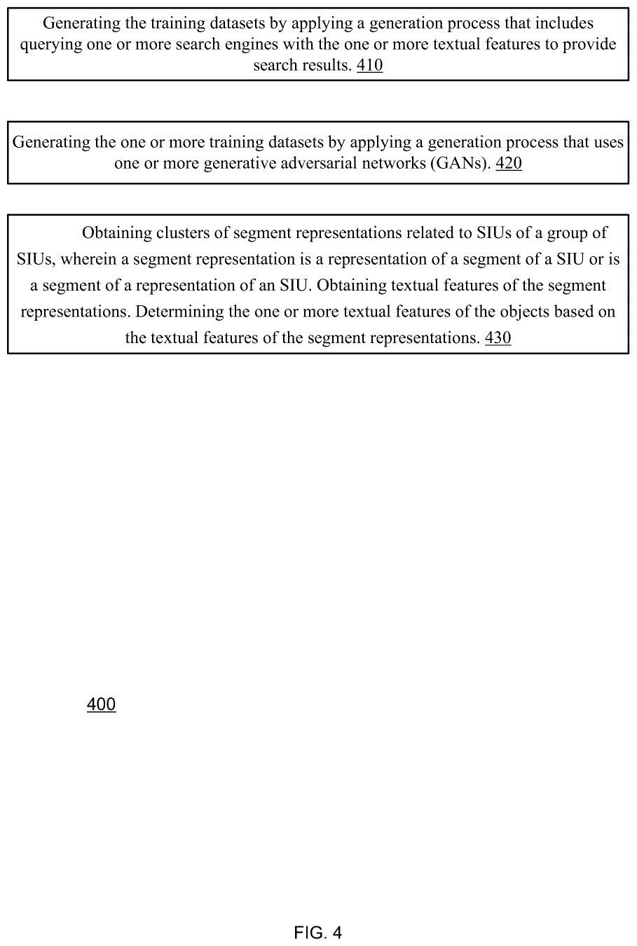

FIG. 4 illustrates an example of method 400 for generating training datasets that can be used for detecting faulty manufactured items based on natural language descriptions (NLDs).

Method 400 may include at least one step out of steps 410, 420 and 430.

Step 410 may include generating the training datasets by applying a generation process that includes querying one or more search engines with the one or more textual features to provide search results. Step 410 may include generating, based on the search results, representations of the one or more textual features.

Step 420 may include generating the one or more training datasets by applying a generation process that uses one or more generative adversarial networks (GANs).

Step 430 may include generating the training data sets by:
obtaining clusters of segment representations related to SIUs of a group of SIUs, wherein a segment representation is a representation of a segment of a SIU or is a segment of a representation of an SIU;
obtaining textual features of the segment representations; and
determining the one or more textual features of the objects based on the textual features of the segment representations.

The obtaining of the textual features of the segment representations may include receiving the textual features of the segment representations from a user.

Method 300 may use one or more neural networks trained by method 400.

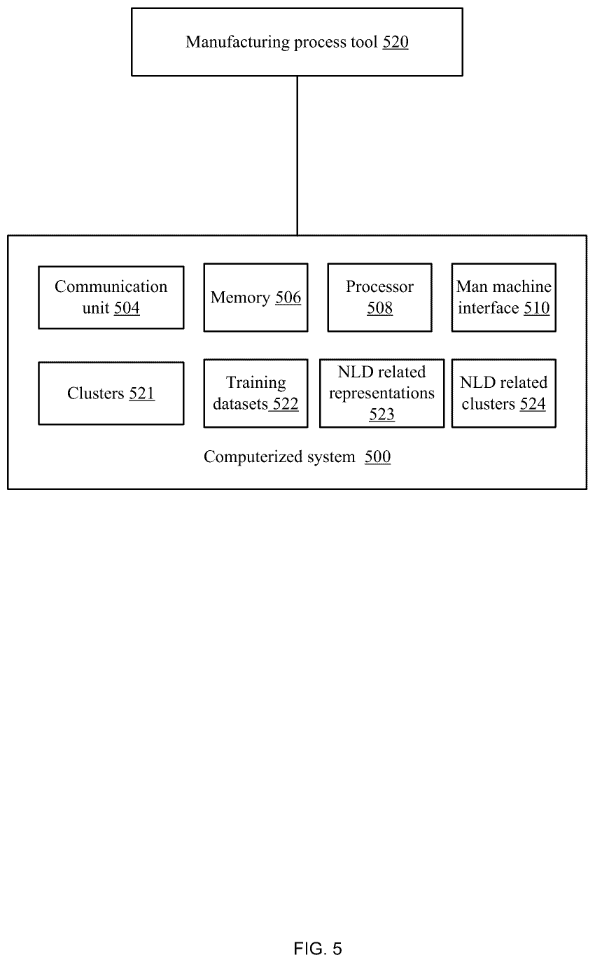

FIG. 5 illustrates an example of a computerized system 500 and a manufacturing process tool 520.

The computerized system 500 may execute method 100 and/or method 200 and/or method 300.

The computerized system 500 may or may not communicate with the manufacturing process tool 520—for example to provide feedback about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may send information regarding the manufactured items that are manufactured by the manufacturing process tool 520, suggestions to amend the manufacturing process applied by the manufacturing process tool 520, and the like.

The computerized system 500 may include a communication unit 504, memory 506, processor 508 and may optionally include a man machine interface 510.

FIG. 5 also illustrates various data structures such as clusters 521, training datasets 522, NLD related representations 523, NLD related clusters 524, and the like.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for detecting faulty manufactured items based on natural language descriptions (NLDs), the method comprises:
obtaining one or more neural networks (NNs) that are trained to detect objects that exhibit one or more textual features of a group of textual features; wherein members of the group are defined by NLDs; wherein the one or more NNs are trained on one or more training datasets, the training datasets are not based on sensed information units (SIUs) of the manufactured items;
receiving a SIU that captures an evaluated manufactured item (EMI);
processing the SIU of the EMI by the one or more NNs, to provide one or more NN processing results regarding one or more relationships between the EMI and the one or more textual features; and
determining a status of the EMI, based on one or more decision rules and the one or more NN processing results.

2. The method according to claim 1 wherein the determining of the status of the EMI comprises determining whether the EMI comprises one or more defects.

3. The method according to claim 1 wherein the one or more NN processing results comprise one or more features match indications that indicate that the EMI exhibits the one or more textual features.

4. The method according to claim 1 wherein the one or more NN processing results comprise one or more features match indications that indicate that (i) the EMI exhibits the one or more textual features, and (ii) a degree of at least one textual feature of the one or more textual features.

5. The method according to claim 1 wherein the one or more NN processing results comprise one or more features match indications that indicate that (i) the EMI exhibits the one or more textual features, and (ii) additional information regarding at least one textual feature of the one or more features.

6. The method according to claim 1 wherein the training datasets are generated by applying a generation process that comprises querying one or more search engines with the one or more textual features to provide search results.

7. The method according to claim 6, wherein the generation process further comprises generating, based on the search results, representations of the one or more textual features.

8. The method according to claim 1 wherein the one or more training datasets are generated by applying a generation process that uses one or more generative adversarial networks (GANs).

9. The method according to claim 1 wherein the training datasets are generated by:
obtaining clusters of segment representations related to SIUs of a group of SIUs, wherein a segment representation is a representation of a segment of a SIU or is a segment of a representation of an SIU;
obtaining textual features of the segment representations; and
determining the one or more textual features of the objects based on the textual features of the segment representations.

10. The method according to claim 9 wherein the obtaining of the textual features of the segment representations comprises receiving the textual features of the segment representations from a user.

11. A non-transitory computer readable medium for detecting faulty manufactured items based on natural language descriptions (NLDs), the non-transitory computer readable medium stores instructions for:
obtaining one or more neural networks (NNs) that are trained to detect objects that exhibit one or more textual features of a group of textual features; wherein members of the group are defined by NLDs; wherein the one or more NNs are trained on one or more training datasets, the training datasets are not based on sensed information units (SIUs) of the manufactured items;
receiving a SIU that captures an evaluated manufactured item (EMI);
processing the SIU of the EMI by the one or more NNs, to provide one or more NN processing results regarding one or more relationships between the EMI and the one or more textual features; and
determining a status of the EMI, based on one or more decision rules and the one or more NN processing results.

12. The non-transitory computer readable medium according to claim 11 wherein the determining of the status of the EMI comprises determining whether the EMI comprises one or more defects.

13. The non-transitory computer readable medium according to claim 11 wherein the one or more NN processing results comprise one or more features match indications that indicate that the EMI exhibits the one or more textual features.

14. The non-transitory computer readable medium according to claim 11 wherein the one or more NN processing results comprise one or more features match indications that indicate that (i) the EMI exhibits the one or more textual features, and (ii) a degree of at least one textual feature of the one or more textual features.

15. The non-transitory computer readable medium according to claim 11 wherein the one or more NN processing results comprise one or more features match indications that indicate that (i) the EMI exhibits the one or more textual features, and (ii) additional information regarding at least one textual feature of the one or more features.

16. The non-transitory computer readable medium according to claim 11 wherein the training datasets are generated by applying a generation process that comprises querying one or more search engines with the one or more textual features to provide search results.

17. The non-transitory computer readable medium according to claim 16, wherein the generation process further comprises generating, based on the search results, representations of the one or more textual features.

18. The non-transitory computer readable medium according to claim 11 wherein the one or more training datasets are generated by applying a generation process that uses one or more generative adversarial networks (GANs).

19. The non-transitory computer readable medium according to claim 11 wherein the training datasets are generated by:
obtaining clusters of segment representations related to SIUs of a group of SIUs, wherein a segment representation is a representation of a segment of a SIU or is a segment of a representation of an SIU;
obtaining textual features of the segment representations; and
determining the one or more textual features of the objects based on the textual features of the segment representations.

20. The non-transitory computer readable medium according to claim 19 wherein the obtaining of the textual features of the segment representations comprises receiving the textual features of the segment representations from a user.
